(19) United States
(12) Patent Application Publication
(10) Pub. No.: US 2003/0102580 A1
(43) Pub. Date: Jun. 5, 2003

(54) Impingment jet aeration

(76) Inventor: Boris M. Khudenko, Atlanta, GA (US)

Correspondence Address: Boris M. Khudenko, 744 Moores Mill Rd., Atlanta, GA, 30327, US

(21) Appl. No.: 09/999,198

(22) Filed: Nov. 30, 2001

(51) Int. Cl. B01F 3/04

(52) U.S. Cl. 261/77; 261/120; 261/123

(57) ABSTRACT

This is an improved impingement jet aeration having steps of airlifting water in the body of the aerator and issuing a water jet into the body of water being aerated, wherein the efficiency of these two steps is greater than the sum of these step. The process is further improved by applying oscillations to the issuing water jet and rocking to a floating version of the aerator. The floating aerator can also be moved over the body of water being aerated. This aerator can also be selfpropelled.

### FIELD OF INVENTION

The present method belongs to aeration of water and wastewater in treatment plants, natural water bodies, man made lakes, and other applications wherein oxygenation, mixing, destratification, deicing, and other actions upon water mass may be required.

### PRIOR ART

A great many aerators are used in water management systems. They are well known in the art. Impingement jet aerators have been studied first by Gameson in England about fifty years ago, and later by others, including the present writer. For example, U.S. Pat. No. 4,482,510 describes a selfpropelled jet aerator. This patent is made a part of present application by inclusion. Impingement jet aerators per se have very high oxygen transfer and mixing efficiencies at water drops of 0.5 to 3 meters. These efficiencies can be well realized when there is a natural water drop, for example, in oxygen saturation of treated effluents, where a drop between a wastewater treatment plant and a river exists. There have been attempts to use impingement jet aerators with water recirculating from the body to be aerated to the impingement jet aerator and back to the aerated body by pumps. For example, the device described in the above cited patent had been tested and showed very good efficiency of the aerator but a poor overall efficiency due to a mismatch between the recycle pump pressure (more than 3 m) and the required jet aerator head (about 1 m). This is a significant problem which precluded a wider use of impingement jet aerators.

The objective of the present invention is to provide an efficient method of utilization of impingement jet aerators.

It is also the objective of the present invention to provide a simple, reliable, and inexpensive method of aeration.

Other objectives of the present invention will become apparent from the ensuing description.

### SUMMARY OF THE INVENTION

This is a method of water aeration with impingement jet aerator having a bottom, side walls, and at least one jet issue means. The jet aerator is provided in a body of water being aerated. The process steps comprise airlifting water from the body of water into the impingement jet aerator, issuing a jet of lifted water through the jet issue means and impinging the jet into the body of water. A two-step aeration occurs, during the airlifting step and during the jet impinging step, wherein the falling jet entraps air from the ambient air into the water. The effect of oxygen transfer is greater than the additive effect of aeration in these two steps due to an entrapment of some airlifting air bubbles into the jet issuing from the aerator and roughing this jet. A rougher jet having a non-smooth surface is trapping more ambient air into the water body being aerated, thus unexpectedly increasing the oxygen transfer. Additionally, the hydraulic efficiency of low-head (0.5 to 3.0 meters) high-flow airlifts is greater than that of high-flow mechanical pumps, if such pumps are available. Therefore, the overall aeration efficiency is increased using a very simple, reliable, and inexpensive device. In many cases multiple aerators can be operated with a single blower for airlifting, while one pump per one aerator is normally required for a pump-jet arrangement.

These jet aerators can be used for drinking water, process water, fish pond water, irrigation water, wastewater, wastewater sludge, mixed liquor, raw wastewater, wastewater undergoing biological treatment, river water, lake water, water in man made reservoir, sea water, and combinations thereof.

The jet issue means can be at least one orifice, at least one opening, at least one nozzle, at least one weir, and combinations thereof. The weirs can be a sharp crested weir, a broad crested weir, a weir with a fixed baffle, a weir with a flow control baffle, a tooth shaped weir, a tooth shaped weir 10 with a tooth shaped baffle, and combinations thereof.

The impingement jet aerator can be a float-supported impingement jet aerators, and rigidly supported impingement jet aerators. Rocking and swinging of the float-supported impingement jet aerator can be provided. This further improves air entrapment and the efficiency of aeration. The method provides for entraining at least a portion of airlift air into the jet issuing from the issuing means. Pulsing of the issuing jet can also be provided. For example, by mechanical means, and also by pulsed, on/off, periodic, and nonuniform feeding of the airlifting air. An example of mechanical means can be a flap, a turbine, or a propeller attached to the jet aerator and mechanically deflecting and pulsing the issuing jet.

The jet aerator sidewall can be preferably circular or rectangular, but it may have another shape, for example, polygonal. The issuing jet can issue from one side of the side wall of the jet aerator, and from multiple sides.

The body of the jet aerator can be provided with at least one inclined baffle installed inside. The baffle can be flat, conical, polygonal, or other. Water rotates around such baffles inside the aerator body thus increasing the airlift efficiency and virtually eliminating the splashing effects. These baffles are described in the U.S. Pat. No. 6,220,822 B1.

A riser is attached to the bottom of the jet aerator and is extended from the bottom to lower reaches of the water body, ultimately to the bottom of such body. The air feed into the riser is connected at a point between the aerator bottom and the lower reaches of the water body.

The air feed can be provided through a line with multiple branches, wherein at least one branch is operated with continuous flow, on/off flow, and combinations thereof. This provides pulsed or variable air feed and induces rocking motions of the floating aerators, and pulsing and swinging motions of the issuing jets in floating and rigidly installed aerators. The airlifting of water to the float-supported impingement jet aerator can be provided with air delivered from such sources as a blower outside the water body, a blower provided on the float-supported impingement jet aerator, a blower driven by an electric motor, a blower driven by an internal combustion engine, a blower driven by a windmill, a blower driven by an electric motor with a solar panel, and combinations thereof. This can accommodate various applications from wastewater treatment plants having stationary blowers beyond the body of the water being treated, to remote lakes having no systematic service access and no regular sources of energy. The airlifting step can be operated manually or automatically.

Similarly to the device described in the U.S. Pat. No. 4,482,510, the present aerator can be made selfpropelled. Additionally, suction side of the riser can be turned in the direction opposite to that of the issuing jet. Both arrangements increase the capacity of this aerator to mix large volumes of water.

### BRIEF DESCRIPTION OF THE DRAWINGS

FIG. 1 is a transverse elevation of an impingement jet aerator with airlift and a schematic presentation of air supply.

FIG. 2 is a front view of an impingement jet aerator.

### DETAILED DESCRIPTION OF EMBODIMENTS

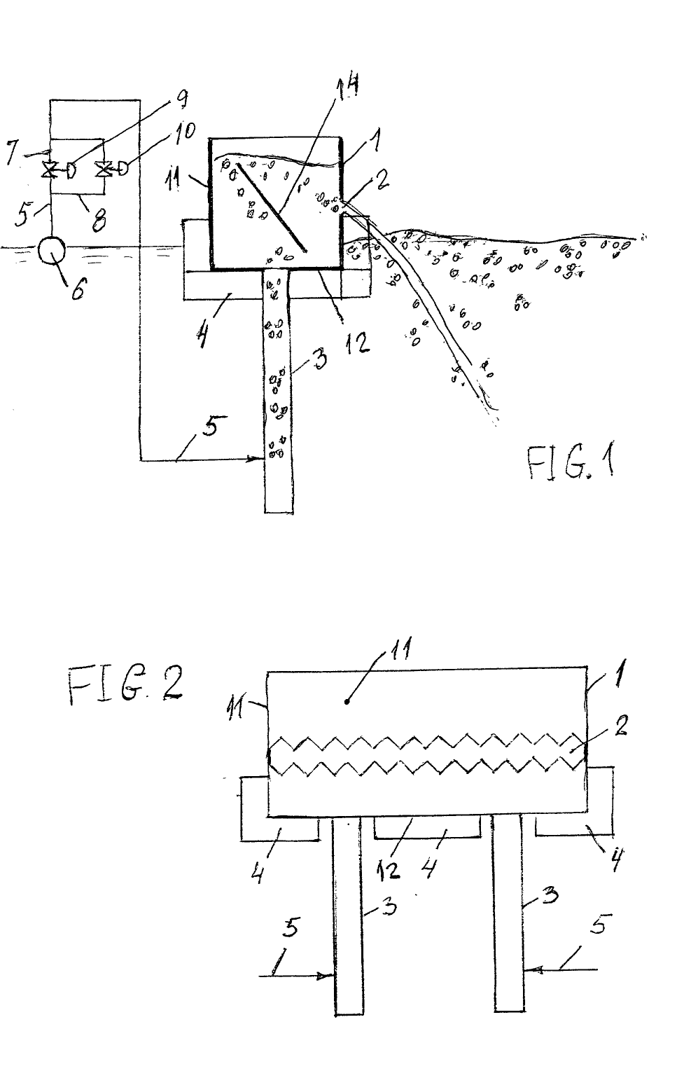

FIGS. 1 and 2 illustrate an impingement jet aerator consisting of a body 1 with a sidewall 11 and bottom 12, a tooth-shaped orifice 2 in a front wall (more than one orifice in more than one wall can be provided), an optional inclined flow rotating baffle 14, floats 4 supporting the aerator, a riser 3 with air pipe 5 having a flexible portion at the jet aerator, pipe 5 is connected to an air main 6 (a floating pipe 6 is shown in this example). The line 5 has branches 7 and 8 with control valves 9 and 10.

The aerator is operated as follows. Air is fed in the riser 3 via line 5 when at least one valve 9 or 10 is open. The air lifts the water inside the body of the aerator. If inclined baffle 14 is installed, the contents of the aerator rotate around the baffle. This improves the airlift efficiency and reduces the splashes. Water with some air bubbles enters the orifice 2 and a water jet issue from the aerator 1 into the water body being aerated. The air bubbles roughen the issued jet thus facilitating better entrainment of air from the ambient air.

When at least one of valves 9 and 10 is operated in the on/off mode, the flow rate of the airlifted water varies.

Accordingly, the water level in the aerator goes up and down and the flow rate of the issuing jet also vary. The jet itself oscillates and rocks the entire body of a floating aerator. Both, jet oscillation and the aerator rocking improve oxygen transfer. Jet oscillations and rocking can be induced by mechanical means attached to the aerator and effecting periodic increases and decreases in the resistance to the outflow of the issuing jet. Many other oscillating means can be devised by skilled in arts. For example, two air branches can be attached at a different height of the riser 3 and operate in the on/off or other variable flow mode.

While the invention has been described in detail with the particular reference to preferred embodiments thereof, it will be understood that variations and modifications can be effected within the spirit and the scope of the invention as previously described and as defined by the claims.

I claim:

1. A method of water aeration with impingement jet aerator having a bottom, side walls, and at least one jet issue means, said jet aerator is provided in a body of said water being aerated, comprising steps of airlifting said water from said body of water into said impingement jet aerator, issuing a jet of said lifted water through said jet issue means and impinging said jet into said body of water.

2. The method of claim 1, wherein said water is a drinking water, a process water, a fish pond water, an irrigation water, a wastewater, a wastewater sludge, a mixed liquor, a raw wastewater, a wastewater during biological treatment, a river water, a lake water, a water in man made reservoir, a sea water, and combinations thereof.

3. The method of claim 1, wherein said issue means is selected from a group consisting of at least one orifice, at least one opening, at least one nozzle, at least one weir, and combinations thereof.

4. The method of claim 3, wherein said weir is selected from a group consisting of a sharp crested weir, a broad crested weir, a weir with a fixed baffle, a weir with a flow control baffle, a tothshaped weir, a tooth shaped weir with a tothshaped baffle, and combinations thereof.

5. The method of claim 1, wherein said impingement jet aerator is selected from a group of float-supported impingement jet aerators, and rigidly supported impingement jet aerators.

6. The method of claim 5, wherein a step of rocking of said float-supported impingement jet aerator is provided.

7. The method of claim 1 and further providing a step of pulsing said issuing jet.

8. The method of claim 7, wherein said pulsing is provided by means selected from the group consisting of mechanical means, pulsed airlifting, periodic airlifting, nonuniform airlifting, and combinations thereof.

9. The method of claim 1, wherein said issuing of jet is selected from the group of issuing said jet on one side of said jet aerator, and on multiple sides of said jet aerator.

10. The method of claim 1, wherein said jet aerator is provided with at least one flow rotating baffle.

11. The method of claim 1, wherein said airlifting is conducted using a riser extended from said bottom of said impingement jet aerator to lower reaches of said water body and further providing air feed into said riser between said bottom and said lower reaches of said water body.

12. The method of claim 11, wherein said air feed is conducted through a line with multiple branches, wherein at least one of said multiple branches is operated in a mode selected from the group of continuous flow, on/off flow, and combinations thereof.

13. The method of claim 5, wherein said step of airlifting to said float-supported impingement jet aerator is provided with air delivered for said airlifting from a source selected from a group consisting of a blower outside said water body, a blower provided on said float-supported impingement jet aerator, blower driven by an electric motor, blower driven by an internal combustion engine, blower driven by a windmill, blower driven by an electric motor with a solar panel, and combinations thereof.

14. The method of claim 1, wherein said step of airlifting is operated in a mode selected from the group consisting of manual operation, automatic operation, and combinations thereof.

15. The method of claim 1, wherein said impingement jet aerator is selfpropelled.
